(19) United States
(12) Patent Application Publication
(10) Pub. No.: US 2019/0257557 A1
(43) Pub. Date: Aug. 22, 2019

(54) RADIATIVE COOLING DEVICE

(71) Applicant: FUJIFILM CORPORATION, Tokyo (JP)

(72) Inventors: Hirotoshi YOSHIZAWA, Kanagawa (JP); Hideki YASUDA, Kanagawa (JP); Tatsuya YOSHIHIRO, Kanagawa (JP)

(21) Appl. No.: 16/362,699

(22) Filed: Mar. 25, 2019

Related U.S. Application Data
(63) Continuation of application No. PCT/JP2017/034213, filed on Sep. 22, 2017.

(30) Foreign Application Priority Data
Sep. 30, 2016 (JP) 2016-194976

(51) Int. Cl. F25B 23/00; F28F 13/18; F25D 31/00; F17C 3/08; F28F 9/20

(52) U.S. Cl. CPC F25B 23/003; F28F 13/18; F25D 31/00; F28F 2013/001; F28F 9/20; F28F 2245/06; F17C 3/08

(57) ABSTRACT

A radiative cooling device including: a vacuum heat insulating container that has an opening portion, that is configured to house an object to be cooled therein and thermally vacuum insulates the object from an exterior thereof; a far-infrared radiator that is arranged between the object and the opening portion in the vacuum heat insulating container, that is thermally vacuum insulated from the exterior of the vacuum heat insulating container, that thermally contacts the object, and that radiates far-infrared rays in a wavelength range of from 8 μm to 13 μm; and a far-infrared transmitting window member that closes the opening portion of the vacuum heat insulating container and that transmits the far-infrared rays radiated from the far-infrared radiator.

### CROSS-REFERENCE TO RELATED APPLICATIONS

This application is a continuation application of International Application No. PCT/JP2017/034213, filed Sep. 22, 2017, the disclosure of which is incorporated herein by reference in its entirety. Further, this application claims priority from Japanese Patent Application No. 2016-194976, filed Sep. 30, 2016, the disclosure of which is incorporated herein by reference in its entirety.

### BACKGROUND OF THE INVENTION

### 1. Field of the Invention

The present disclosure relates to a radiative cooling device.

### 2. Description of the Related Art

Radiative Cooling is a Well-Known Natural Phenomenon.

In recent years, a radiative cooling device using radiative cooling is being studied in a viewpoint of energy savings and so forth.

For example, there is known a radiative cooling device for cooling an object to be cooled, the radiative cooling device including a plurality of different materials arranged in a depth direction thereof with respect to the object, the plurality of different materials including a solar-spectrum reflecting portion and a heat radiator (for example, see the specification of US2015/0338175A).

In addition, there is known a radiative cooling device consisting of a heat insulating container whose one surface has an opening, a light transmitting plate that covers the opening of the heat insulating container, a heat radiator provided inside the light transmitting plate so as to cover the opening, and an inlet and outlet portion through which an object to be cooled is inserted to and removed from the inside of the heat radiator (for example, see JP1986-223468A (JP-561-223468A)). The light transmitting plate is formed of a crystal body of TlBr.T11, or a plate body consisting of an As₂Se₃-based glass or a Ge₃₃Ad₁₂Se₅₅-based glass having high infrared transmissivity. The heat radiator contacts the object, and is formed of a metal plate having high reflectance and high heat conductance and a coating that coats the metal plate and that consists of TiO₂ having high reflectance for solar rays and high emittance for infrared rays.

### SUMMARY OF THE INVENTION

However, with the technology described in the specification of US2015/0338175A, heat conduction from the solar-spectrum reflecting portion to the heat radiator may cause a decrease in radiative cooling performance.

With the technology described in JP1986-223468A (JP-S61-223468A), heat conduction from the light transmitting plate that covers the opening to the heat radiator may cause a decrease in radiative cooling performance.

An object of an aspect of the present disclosure is to provide a radiative cooling device having improved radiative cooling performance.

Means for attaining the object includes the following aspect.

<1> A radiative cooling device comprising:

a vacuum heat insulating container that comprises a container wall and an opening portion, the vacuum heat insulating container being configured to house an object to be cooled at an interior thereof and thermally vacuum insulate the object from an exterior thereof;

a far-infrared radiator that is arranged between the object and the opening portion in the vacuum heat insulating container, that is thermally vacuum insulated from the exterior of the vacuum heat insulating container, that thermally contacts the object, and that radiates far-infrared rays in a wavelength range of from 8 μm to 13 μm; and

a far-infrared transmitting window member that closes the opening portion of the vacuum heat insulating container and that transmits the far-infrared rays radiated from the far-infrared radiator.
<2> The radiative cooling device according to <1>, wherein the vacuum heat insulating container thermally vacuum insulates the object and the far-infrared radiator from the exterior of the vacuum heat insulating container with a degree of vacuum of 10 Pa or less.

<3> The radiative cooling device according to <1> or <2>,

wherein the far-infrared radiator has an average emittance E₈₋₁₃ in the wavelength range, in a radiation direction of the far-infrared rays, of 0.80 or more, and

wherein the far-infrared transmitting window member has an average transmittance T₈₋₁₃ in the wavelength range, in a transmission direction of the far-infrared rays, of 0.40 or more.

<4> The radiative cooling device according to any one of <1> to <3>, wherein the far-infrared radiator is a blackbody radiator.

<5> The radiative cooling device according to any one of <1> to <4>, wherein an E₈₋₁₃/E₅₋₂₅ ratio, which is a ratio of an average emittance E₈₋₁₃ of the far-infrared radiator in the wavelength range of from 8 μm to 13 μm in a radiation direction of the far-infrared rays to an average emittance E₅₋₂₅ of the far-infrared radiator in a wavelength range of from 5 μm to 25 μm in the radiation direction of the far-infrared rays, is 1.20 or more.

<6> The radiative cooling device according to any one of <1> to <5>, wherein the far-infrared transmitting window member has, at a surface thereof on a side opposite from a surface thereof on a side of the far-infrared radiator, a solar-radiation reflectance of 80% or more.

<7> The radiative cooling device according to any one of <1> to <6>, wherein a T₈₋₁₃/T₅₋₂₅ ratio, which is a ratio of an average transmittance T₈₋₁₃ of the far-infrared transmitting window member in the wavelength range of from 8 μm to 13 μm in a transmission direction of the far-infrared rays to an average transmittance T₅₋₂₅ of the far-infrared transmitting window member in a wavelength range of from 5 μm to 25 μm in the transmission direction of the far-infrared rays, is 1.20 or more.

<8> The radiative cooling device according to any one of <1> to <7>, further comprising an internal far-infrared reflecting film that is arranged at least between an inner wall surface of the vacuum heat insulating container and the object and that reflects far-infrared rays in a wavelength range of from 5 μm to 25 μm radiated from the inner wall surface when the far-infrared rays in the wavelength range of from 5 μm to 25 μm are radiated from the inner wall surface.

<9> The radiative cooling device according to any one of <1> to <8>, further comprising a metal cylindrical member that is arranged on a side opposite from a side of the far-infrared radiator when viewed from the far-infrared transmitting window member and through which the far-infrared rays transmitted through the far-infrared transmitting window member pass.

<10> The radiative cooling device according to any one of <1> to <9>, further comprising a support member that is arranged at an inner wall surface of the vacuum heat insulating container and that supports the object.

With the aspect of the present disclosure, a radiative cooling device having improved radiative cooling performance is provided.

### BRIEF DESCRIPTION OF THE DRAWINGS

FIG. 1 is a schematic cross-sectional view conceptually showing a radiative cooling device that is an example of a radiative cooling device of the present disclosure;

FIG. 2 is a graph showing the relationship between a λ(G)/λ(G,0) ratio and K(=Lₘₑₐₙ/L ratio) in the example of the radiative cooling device of the present disclosure;

FIG. 3 is a schematic cross-sectional view conceptually showing a radiative cooling device that is another example of the radiative cooling device of the present disclosure; and

FIG. 4 is a graph showing the relationship between the time that has elapsed since the start of evaluation, and the temperature of an object to be cooled and the outside air temperature in Example 1.

### DESCRIPTION OF THE PREFERRED EMBODIMENTS

In this specification, a numerical-value range expressed using sign “−” represents a range including numerical values written before and after “−” as the lower limit value and the upper limit value.

In this specification, when a plurality of substances corresponding to a component exist in a composition, the amount of the component in the composition represents the total amount of the plurality of substances existing in the composition unless otherwise noted.

In this specification, “far-infrared rays” without limitation of the wavelength range represent electromagnetic waves in a wavelength range of 5 μm-25 μm, and “far-infrared rays in a wavelength range of 8 μm-13 μm ” represent far-infrared rays in a wavelength range of 8 μm-13 μm included in the above-described far-infrared rays.

A radiative cooling device of the present disclosure includes

a vacuum heat insulating container that has an opening portion, and that is configured to house an object to be cooled at an interior thereof and thermally vacuum insulates the object from an exterior thereof;

a far-infrared radiator that is arranged between the object and the opening portion in the vacuum heat insulating container, that is thermally vacuum insulated from the exterior of the vacuum heat insulating container, that thermally contacts the object, and that radiates far-infrared rays in a wavelength range of 8 μm-13 μm (hereinafter, also referred to as “specific far-infrared rays”); and

a far-infrared transmitting window member that closes the opening portion of the vacuum heat insulating container and that transmits the specific far-infrared rays radiated from the far-infrared radiator.

With the radiative cooling device, radiative cooling performance is improved as compared with a case where a far-infrared radiator and an object to be cooled are not housed in a container and a case where a far-infrared radiator and an object to be cooled are housed in a container but are not thermally vacuum insulated from the exterior of the container. The advantageous effect can be attained during both the daytime and the nighttime.

The reason that the advantageous effect is attained is expected as follows.

When the object is housed in the vacuum heat insulating container of the object device of the present disclosure, the specific far-infrared rays (that is, the far-infrared rays in the wavelength range of 8 μm-13 μm) are radiated from the far-infrared radiator that thermally contacts the object. The wavelength range (8 μm-13 μm) of the specific far-infrared rays is a wavelength range called “atmospheric window”, and is a wavelength range with high transmittance for electromagnetic waves that pass through the atmosphere. Thus, the specific far-infrared rays radiated from the far-infrared radiator that thermally contacts the object are transmitted through the far-infrared transmitting window member, then are transmitted through the atmosphere without being absorbed by the atmosphere, and reach the sky (that is, the space). Consequently, the object is cooled by a radiative cooling phenomenon.

In the radiative cooling device of the present disclosure, the far-infrared radiator and the object are housed in the vacuum heat insulating container and are thermally vacuum insulated from the exterior of the vacuum heat insulating container. Thus, a decrease in radiative cooling performance caused by heat inflow from the exterior of the vacuum heat insulating container, as well as heat convection and heat conduction in the vacuum heat insulating container is suppressed. Consequently, with the radiative cooling device of the present disclosure, radiative cooling performance is improved as compared with the case where the far-infrared radiator and the object are not housed in the container and the case where the far-infrared radiator and the object are housed in the container but are not thermally vacuum insulated from the exterior of the container.

An example of a radiative cooling device of the present disclosure is described below with reference to the drawings. It is to be noted that the radiative cooling device of the present disclosure is not limited to the example described below.

In the drawings, the same reference sign is applied to the members having substantially the same function, and the redundant description may be omitted in the specification.

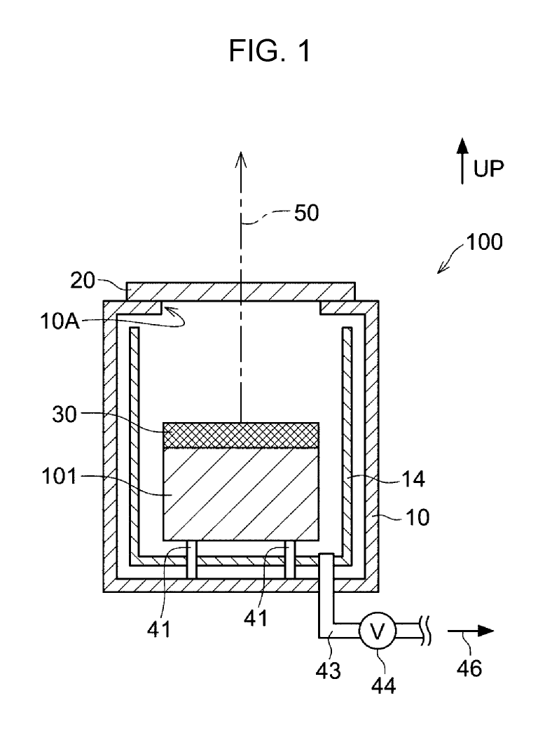

FIG. 1 is a schematic cross-sectional view conceptually showing a state in which a radiative cooling device that is the example of the radiative cooling device of the present disclosure houses an object to be cooled in a vacuum heat insulating container and is arranged outdoors such that an opening portion of the vacuum heat insulating container faces upward (in a direction indicated by arrow UP in FIG. 1, in a direction of the sky).

As shown in FIG. 1, a radiative cooling device 100 includes a vacuum heat insulating container 10.

The vacuum heat insulating container 10 is a container that houses an object to be cooled 101 therein and that thermally insulates the object 101 from the exterior.

The vacuum heat insulating container 10 has, in an upper surface thereof, an opening portion 10A.

One end of a pipe 43 including a valve 44 is connected to the vacuum heat insulating container 10. A vacuum pump (not shown) is connected to the other end of the pipe 43. In this example, by activating the vacuum pump and opening the valve 44, a vacuum can be formed in the vacuum heat insulating container 10 (that is, the air can be evacuated).

In the present disclosure, “vacuum (state)” represents a state in which the pressure is lower than the atmospheric pressure. In this case, a specific degree of vacuum in the vacuum heat insulating container 10 is not particularly limited.

In the present disclosure, the degree of vacuum in the vacuum heat insulating container 10 preferably meets at least one of satisfying inequality (1) (described later) or being 100 Pa or less (preferably, 10 Pa or less) in a viewpoint of more effectively suppressing heat conduction (that is, heat inflow) from the exterior to the object and the far-infrared radiator and further improving the radiative cooling performance of the device.

The radiative cooling device 100 includes a far-infrared transmitting window member 20 that closes the opening portion 10A of the vacuum heat insulating container 10. The far-infrared transmitting window member 20 has a function of transmitting specific far-infrared rays 50 radiated from a far-infrared radiator 30 (described later).

While the far-infrared transmitting window member 20 is a member that covers the opening portion 10A of the vacuum heat insulating container 10, a far-infrared transmitting window member is not limited to the aspect of the far-infrared transmitting window member 20. For example, a far-infrared transmitting window member may be a member that is fitted into an opening portion of a vacuum heat insulating container.

The radiative cooling device 100 includes the far-infrared radiator 30 in the vacuum heat insulating container 10. The far-infrared radiator 30 has a function of radiating the specific far-infrared rays 50.

In the state (the state in FIG. 1) in which the object 101 is housed in the vacuum heat insulating container 10, the far-infrared radiator 30 thermally contacts the object 101.

In this case, a situation in which the far-infrared radiator 30 thermally contacts the object 101 represents a situation in which the far-infrared radiator 30 contacts the object 101 directly or via a heat conductive member (for example, metal member).

The far-infrared radiator 30 does not have to be fixedly arranged in the vacuum heat insulating container 10. For example, after the object 101 is housed in the vacuum heat insulating container 10, the far-infrared radiator 30 may be placed on the object 101 directly or via a heat conductive member.

In addition, a plurality of support pins 41 are provided on a bottom surface in the vacuum heat insulating container 10, and serve as support members for supporting the object 101. The object 101 is supported by the plurality of support pins 41. In this example, with the above-described structure, heat conduction from a bottom portion of the vacuum heat insulating container 10 to the object 101 is further suppressed, and more effective vacuum heat insulation is provided.

The material of the plurality of support pins 41 may be metal (for example, steel), ceramics, or resin.

The shape of each of the plurality of support pins 41 is not particularly limited. The shape of each of the plurality of support pins 41 may be, for example, a columnar shape, a conical shape, a prism shape, a pyramid shape, or a screw shape.

A support member for supporting the object 101 may be provided on a side surface in the vacuum heat insulating container 10 instead of the bottom surface in the vacuum heat insulating container 10 or in addition to the bottom surface in the vacuum heat insulating container 10. In short, a support member may be at least a member that decreases the contact area between an inner wall surface of the vacuum heat insulating container 10 and a subset of the object 101 and the far-infrared radiator 30.

Although the details are described later, a support member for supporting the object 101 is not an essential member, and may be omitted.

In this specification, “heat insulation” represents suppressing heat conduction, and a specific heat conductance is not particularly limited. The heat conductance of “heat insulation” in the present disclosure is preferably less than 0.1 W/(m·K), or more preferably equal to or less than 0.08 W/(m·K).

The radiative cooling device 100 includes an internal far-infrared reflecting film 14 that is arranged between the inner wall surface of the vacuum heat insulating container 10 and the subset of the far-infrared radiator 30 and the object 101, and when far-infrared rays in a wavelength range of 5 μm-25 μm are radiated from the inner wall surface, reflects far-infrared rays in the wavelength range of 5 μm-25 μm radiated from the inner wall surface. In this example, the internal far-infrared reflecting film 14 is arranged along the inner wall surface of the vacuum heat insulating container 10. The internal far-infrared reflecting film 14 may contact at least part of the inner wall surface of the vacuum heat insulating container 10 or may not contact the inner wall surface.

The internal far-infrared reflecting film 14 is not an essential member, and may be omitted.

Cooling of an object to be cooled using the radiative cooling device 100 is described below.

When an object to be cooled is to be cooled using the radiative cooling device 100, first the object 101 is housed in the vacuum heat insulating container 10, and then the far-infrared radiator 30 is brought into thermally contact with the object 101 in the vacuum heat insulating container 10. Then, the opening portion 10A of the vacuum heat insulating container 10 is covered with the far-infrared transmitting window member 20, the far-infrared transmitting window member 20 is fixed, and thus the opening portion 10A is closed. Then, in a state in which the valve 44 is open, a vacuum is formed (see vacuum forming direction 46 in FIG. 1) in the vacuum heat insulating container 10 via the pipe 43 until the degree of vacuum becomes a desirable degree of vacuum (for example, 100 Pa or less).

In a state in which the interior of the vacuum heat insulating container 10 is held at the desirable degree of vacuum, the specific far-infrared rays 50 radiated from the far-infrared radiator 30, which thermally contacts the object 101, are transmitted through the far-infrared transmitting window member 20 and dissipated to the outside of the radiative cooling device 100. The specific far-infrared rays 50 dissipated to the outside of the radiative cooling device 100 are transmitted through the atmosphere without being absorbed by the atmosphere, and reach the sky (that is, the space). Consequently, the object 101 is cooled by a radiative cooling phenomenon.

In the radiative cooling device 100, the far-infrared radiator 30 and the object 101 are housed in the vacuum heat insulating container 10 and are thermally vacuum insulated from the exterior of the vacuum heat insulating container 10. Thus, a decreased in radiative cooling performance caused by heat conduction (that is, heat inflow) from the exterior of the vacuum heat insulating container 10 is suppressed. Consequently, with the radiative cooling device 100, radiative cooling performance is improved as compared with the case where the far-infrared radiator and the object are not housed in the container and the case where the far-infrared radiator and the object are housed in the container but are not thermally vacuum insulated from the exterior of the container.

In addition, since the radiative cooling device 100 includes the internal far-infrared reflecting film 14 in the vacuum heat insulating container 10, even when the far-infrared rays in the wavelength range of 5 μm-25 μm are radiated from the inner wall surface of the vacuum heat insulating container 10, radiation of the far-infrared rays to the far-infrared radiator 30 and the object 101 (that is, heat radiation) can be suppressed. Thus, radiative cooling performance is further improved.

In FIG. 1, regarding the arrangement angle of the entire radiative cooling device 100, while the opening portion 10A of the vacuum heat insulating container 10 faces directly upward (that is, in a direction opposite to the direction of gravity), the arrangement angle of the entire radiative cooling device 100 is not limited to the angle. The arrangement angle of the entire radiative cooling device 100 may be arrangement in which an opening portion of a vacuum heat insulating container faces obliquely upward. In short, the arrangement angle of the entire radiative cooling device 100 may be any angle as long as the angle allows the specific far-infrared rays 50 radiated from the far-infrared radiator 30 to be radiated toward the sky via the far-infrared transmitting window member 20. The arrangement angle of the entire radiative cooling device 100 may be an arrangement angle at which the opening portion of the vacuum heat insulating container faces a direction that differs from the direction of the sun in a viewpoint of suppressing heat inflow due to solar rays.

Next, preferable aspects of an object to be cooled and a radiative cooling device according to the present disclosure are described.

### Cooling Object

As an object to be cooled (for example, cooling object 101) of the present disclosure, a desirable object can be appropriately selected and used, and the object is not particularly limited.

An object to be cooled is preferably a solid, such as a resin body or a metal body based on the principle of the radiative cooling device of the present disclosure using vacuum heat insulation. However, liquid such as water or gas such as water vapor may serve as an object to be cooled by housing the liquid or gas in a vacuum heat insulating container while the liquid or gas is confined in a container. Of course, an object to be cooled being a solid (ice, resin body, or metal body) may be housed in a vacuum heat insulating container while the solid is confined in a container.

For the container for confining an object to be cooled, a desirable material can be appropriately selected and used, and the material is not particularly limited.

A specific example of the material of the container for confining an object to be cooled is similar to a specific example of the material of a vacuum heat insulating container (described later) and a preferable aspect thereof is also similar to the specific example.

### Vacuum Heat Insulating Container

The radiative cooling device of the present disclosure includes a vacuum heat insulating container (for example, the above-described vacuum heat insulating container 10).

The vacuum heat insulating container is a container that houses an object to be cooled in the vacuum heat insulating container and that thermally vacuum insulates the housed cooling object from the exterior of the vacuum heat insulating container.

The vacuum heat insulating container may have any configuration as long as the configuration exhibits the above-described function, and the specific configuration is not particularly limited. The vacuum heat insulating container does not have to constantly maintain a vacuum, and the interior of the vacuum heat insulating container may be at a normal pressure during storage or transportation. In this case, it is enough to attain the above-described vacuum heat insulation by coupling the vacuum heat insulating container to, for example, a vacuum pump during use for cooling the object. The vacuum heat insulating container has a strength that withstands generation of a necessary vacuum at least when the object is cooled.

The material of a container body of the vacuum heat insulating container is not particularly limited.

The material of the container body is preferably a metal material or an inorganic material other than the metal material.

The metal material may be metal, such as copper, silver, or aluminum; or an alloy, such as stainless steel or an aluminum alloy.

The inorganic material other than the metal material may be glass, such as soda glass, potash glass, or lead glass; ceramics such as PLZT (lead lanthanum zirconate titanate); quartz; fluorite; or sapphire.

The material of the container body is preferably a metal material having high performance of reflecting solar rays which are a main heat inflow source or radiant heat, or more preferably aluminum, silver, an aluminum alloy, or stainless steel, in a viewpoint of suppressing heat inflow from the exterior.

The material of the container body may be a material in which an inorganic material other than a metal material is coated with a metal material.

The thickness of the vacuum heat insulating container can be appropriately set with regard to the strength and the degree of heat insulation of the vacuum heat insulating container.

In addition, the vacuum heat insulating container has an opening portion (for example, the above-described opening portion 10A).

The opening portion of the vacuum heat insulating container functions as an outlet of specific far-infrared rays radiated from a far-infrared radiator.

The specific far-infrared rays dissipated to the exterior of the vacuum heat insulating container via the opening portion are transmitted through a far-infrared transmitting window member (described later) that closes the opening portion, are further transmitted through the atmosphere, and reach the sky.

The shape in plan view of the opening portion may be an elliptic shape (including a circular shape), a rectangular shape (including a square shape), or a polygonal shape other than the rectangular shape. The shape in plan view of the opening portion may be an indeterminate shape other than the above-listed shapes.

The shape in plan view of the opening portion may be preferably an elliptic shape, or more preferably a circular shape in a viewpoint of easy working.

The opening portion of the vacuum heat insulating container may have a function as an outlet and inlet for an object to be cooled.

Alternatively, the vacuum heat insulating container may have an outlet and inlet for an object to be cooled in addition to the opening portion.

The vacuum heat insulating container may be configured to allow an object to be cooled to be inserted into the vacuum heat insulating container and to be removed from the vacuum heat insulating container. With this configuration, an object to be cooled may not be housed in the vacuum heat insulating container except when the object is cooled.

In other words, the vacuum heat insulating container has an object to be cooled housing portion. An object to be cooled may be removably housed in the object housing portion or may be fixed at the object housing portion. Such an object to be cooled housing portion may be a space including a certain support structure in a peripheral portion of the space. For example, the object housing portion may be an inner space of a certain container.

In this viewpoint, a radiative cooling device according to an embodiment is provided, the radiative cooling device including

a vacuum heat insulating container that has an opening portion, that includes therein an object to be cooled housing portion, and that thermally vacuum insulates the object housing portion from exterior when an interior is reduced in pressure;

a far-infrared radiator that is arranged between the object housing portion and the opening portion in the vacuum heat insulating container, that is thermally vacuum insulated from the exterior of the vacuum heat insulating container when the interior of the vacuum heat insulating container is reduced in pressure, that thermally contacts the object housing portion, and that radiates far-infrared rays in a wavelength range of 8 μm-13 μm; and

a far-infrared transmitting window member that closes the opening portion of the vacuum heat insulating container and that transmits the far-infrared rays radiated from the far-infrared radiator.

The reduction in pressure may be, for example, reduction in pressure to a degree of vacuum of 1.0×10⁻⁹ Pa-100 Pa, or reduction in pressure to a degree of vacuum of 1.0×10⁻⁵ Pa-10 Pa. With such a radiative cooling device, by arranging an object to be cooled in the object housing portion and by reducing the pressure in the vacuum heat insulating container using a vacuum pump or the like, the radiative cooling device can be used for cooling a cooling member. Therefore, a use of the radiative cooling device for cooling an object to be cooled is also provided.

In addition, a cooling kit is provided, the cooling kit including

a container that has a container wall and an opening, that includes therein an object to be cooled housing portion at a position separated from the container wall, and that has a strength that withstands pressure reduction of an interior of the container to 100 Pa or less;

a far-infrared radiator that radiates far-infrared rays in a wavelength range of 8 μm-13 μm;

a far-infrared transmitting window member that transmits the far-infrared rays when being arranged so as to close the opening of the container; and

an instruction that describes a process of cooling an object to be cooled by arranging the object in the object housing portion, arranging the far-infrared radiator between the object and the opening in the vacuum heat insulating container so as to thermally contact the object and to be separated from the container wall, closing the opening of the container using the far-infrared transmitting window member, and reducing the pressure of the interior of the container to 100 Pa or less.

Further, a use of the cooling kit for cooling an object to be cooled is also provided.

The sizes of the vacuum heat insulating container and the opening portion are not particularly limited, and may be appropriately set depending on the purpose.

The height of the vacuum heat insulating container (that is, the length of the vacuum heat insulating container in a radiation direction in which the specific far-infrared rays are radiated from the far-infrared radiator) is, for example, 10 mm-2 m, preferably 10 mm-500 mm, or more preferably 100 mm-300 mm.

The maximum length of the vacuum heat insulating container (that is, the maximum length in a direction orthogonal to the height direction; for example, the diameter when the vacuum heat insulating container has a columnar shape) is, for example, 10 mm-30 m, preferably 10 mm-1000 mm, or more preferably 100 mm-500 mm.

The maximum length of the opening portion of the vacuum heat insulating container (that is, the diameter when the opening portion has a circular shape) is, for example, 10 mm-30 m, preferably 10 mm-1000 mm, or more preferably 50 mm-210 mm.

### Desirable Degree of Vacuum

The vacuum heat insulating container houses the object and the far-infrared radiator, and thermally vacuum insulates the object and the far-infrared radiator from the exterior.

A specific degree of vacuum in vacuum heat insulation is not particularly limited; however, the degree of vacuum is preferably 100 Pa or less, or more preferably 10 Pa or less, in a viewpoint of further improving radiative cooling performance by further suppressing heat inflow to the object and the far-infrared radiator. The lower limit of the degree of vacuum is not particularly limited; however, the lower limit of the degree of vacuum may be, for example, 1.0×10⁻⁹ Pa or more, 1.0×10⁻⁵ Pa or more, or 1.0×10⁻¹ Pa or more due to technical constraints.

Alternatively, the degree of vacuum in vacuum heat insulation is preferably a degree of vacuum that satisfies the following inequality (1), in a viewpoint of further improving radiative cooling performance by further suppressing heat inflow to the object and the far-infrared radiator.

$$P \leq \frac{9 \sqrt{2} β {k}_{B} T}{π {d}^{ 2} L} \qquad Inequality ( 1 )$$

In the inequality (1), P denotes a degree of vacuum (Pa) in vacuum heat insulation, β denotes a value of 1.5-2.0, k_{B} denotes the Boltzmann constant, T denotes a temperature (K) in the vacuum heat insulating container, d denotes a diameter (m) of gas molecules in the vacuum heat insulating container, and L denotes the shortest distance (m) between the vacuum heat insulating container and the object.

The inequality (1) is described below in more details.

The inequality (1) represents that, when λ(G,0) denotes a heat conductance under the atmospheric pressure of a gas G sealed in the vacuum heat insulating container and λ(G) denotes a heat conductance at a degree of vacuum P (Pa) of the gas G sealed in the vacuum heat insulating container, a λ(G)/X(G,0) ratio is 0.90 or less.

To be more specific, when L denotes the shortest distance (m) between the vacuum heat insulating container and the object, Lₘₑₐₙ is a mean free path of the gas G at the degree of vacuum P (Pa) in vacuum heat insulation, K is an Lₘₑₐₙ/L ratio, and β is a value of 1.5-2.0, the following relation (F1) is established between the λ(G)/λ(G,0) ratio and K (=Lₘₑₐₙ/L ratio).

λ(G)/λ(G,0)ratio=1/(1+2βK) Relation (F1)

The above-described relation (F1) is an expression derived from expression (4) on pp. 149 in Energy and Buildings, Volume 42, Issue 2, pp. 147-272 (February 2010).

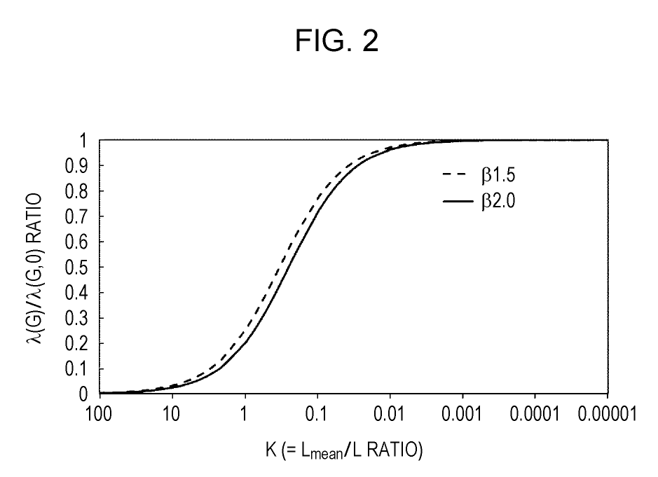

FIG. 2 is a graph showing the relationship between the λ(G)/λ(G,0) ratio and K (=Lₘₑₐₙ/L ratio).

In FIG. 2, a dotted line is a curve when β is 1.5, and a solid line is a curve when β is 2.0.

The inventors and others experimentally found that heat inflow to the object and the far-infrared radiator is further suppressed and radiative cooling performance is further improved in a region where the λ(G)/λ(G,0) ratio is 0.90 or less (that is, the λ(G)/λ(G,0) ratio plotted along the vertical axis of the graph in FIG. 2 is 0.90 or less).

The finding is expressed by the following relation (F2).

λ(G)/λ(G,0)ratio=1/(1+2βK)=1/(1+2β×(Lₘₑₐₙ/L)≤0.90 Relation (F2)

The mean free path Lₘₑₐₙ theoretically satisfies the following relation (F3).

Lₘₑₐₙ=k_{B}T/√2πd²P Relation (F3)

In the relation (F3), P denotes a degree of vacuum (Pa) in vacuum heat insulation, k_{B} denotes the Boltzmann constant, T denotes a temperature (K) in the vacuum heat insulating container, and d denotes a diameter (m) of gas molecules in the vacuum heat insulating container.

By substituting Lₘₑₐₙ of relation (F3) into relation (F2), and modifying the relation (F2), the above-described inequality (1) is derived.

That is, the above-described inequality (1) represents that the λ(G)/λ(G,0) ratio is 0.90 or less.

An example of inequality (1) may be that β is 2.0, and d is 0.36×10⁻⁹ m. In this case, 0.36×10⁻⁹ m is an average diameter of molecules in the atmosphere (that is, nitrogen molecules and oxygen molecules).

### Support Member

The radiative cooling device of the present disclosure may include at least one support member (for example, the above-described support pin 41) for supporting the object, at an inner wall surface (that is, a bottom surface and/or a side surface) of the vacuum heat insulating container. Thus, the contact area between the inner wall surface of the vacuum heat insulating container and the object can be decreased (or contact between the inner wall surface of the vacuum heat insulating container and the object can be avoided), and hence heat conduction from the inner wall surface of the vacuum heat insulating container to the object can be further suppressed.

The material of the support member may be metal (for example, steel), ceramics, or resin.

The resin may be, for example, acrylic resin, phenolic resin, epoxy resin, or ABS resin (acrylonitrile butadiene styrene copolymer resin). In particular, phenolic resin is preferable in a viewpoint of low heat conductance.

The shape of the support member is not particularly limited. The shape of the support member may be, for example, a columnar shape, a conical shape, a prism shape, a pyramid shape, a spherical shape, or a plate shape.

The radiative cooling device of the present disclosure is not limited to one including the support member for supporting the object.

For example, an advantageous effect similar to that in the case provided with the support member can be obtained by lifting up the object from the bottom surface of the vacuum heat insulating container using a repulsive force such as a magnetic force, and hence achieving noncontact between the inner wall surface of the vacuum heat insulating container and the object.

The aspect in which the object is lifted up using a magnetic force can be realized by providing a magnetic material such as a magnet at the bottom surface of the vacuum heat insulating container.

In addition, an advantageous effect similar to that of the case provided with the support member can be obtained by providing an internal heat insulating layer (described later). Internal Heat Insulating Layer

The radiative cooling device of the present disclosure may include an internal heat insulating layer that is arranged along at least part of the inner wall surface of the vacuum heat insulating container and that thermally insulates the internal wall surface of the vacuum heat insulating container and the object from each other.

The word “internal” of the internal heat insulating layer represents the interior of the vacuum heat insulating container.

The internal heat insulating layer may also function as a support member that supports the object.

That is, by providing the internal heat insulating layer between the inner wall surface of the vacuum heat insulating container and the object, the contact area between the inner wall surface of the vacuum heat insulating container and the object can be decreased (or contact between the inner wall surface of the vacuum heat insulating container and the object can be avoided), and hence heat conduction from the inner wall surface of the vacuum heat insulating container to the object can be further suppressed.

For the heat insulating material forming the internal heat insulating layer, a desirable material can be appropriately selected and used, and the material is not particularly limited. For the heat insulating material forming the internal heat insulating layer, a resin material having gas cells, for example, silica aerogel, polystyrene foam, glass wool, or a gas cellular cushioning material may be used.

A commercially available product of the gas-cell cushioning material may be Aircap (registered trademark, Sakai Chemical Industry Co., Ltd.), Putiputi (registered trademark, Kawakami Sangyo Co., Ltd.), or Minapack (registered trademark, Sakai Chemical Industry Co., Ltd.).

### Internal Far-Infrared Reflecting Film

The radiative cooling device of the present disclosure may further include an internal far-infrared reflecting film (for example, the above-described internal far-infrared reflecting film 14) that is arranged at least between the inner wall surface (that is, the side surface and/or the bottom surface) of the vacuum heat insulating container and the object, and when far-infrared rays in a wavelength range of 5 μm-25 μm are radiated from the inner wall surface, reflects the far-infrared rays in the wavelength range of 5 μm-25 μm radiated from the inner wall surface.

The internal far-infrared reflecting film may be arranged, for example, along at least part of the inner wall surface of the vacuum heat insulating container. The internal far-infrared reflecting film may contact at least part of the inner wall surface of the vacuum heat insulating container or may not contact the inner wall surface.

The internal far-infrared reflecting film is preferably arranged between the inner wall surface of the vacuum heat insulating container and the subset of the object and the far-infrared radiator.

When the radiative cooling device of the present disclosure includes the internal far-infrared reflecting film, even when the far-infrared rays in the wavelength range of 5 μm-25 μm are radiated from the inner wall surface of the vacuum heat insulating container, radiation of the far-infrared rays from the vacuum heat insulating container to the object (that is, heat radiation) can be suppressed. Thus, radiative cooling performance is further increased.

The internal far-infrared reflecting film has an average reflectance R₅₋₂₅ in the wavelength range of 5 μm-25 μm, the average reflectance R₅₋₂₅ being preferably 0.40 or more, more preferably 0.60 or more, or particularly preferably 0.80 or more.

In this specification, the average reflectance R₅₋₂₅ represents an arithmetic mean value of spectral reflectances for wavelengths included in a wavelength range of 5 μm-25 μm in Appendix Table 3 in JIS R 3106:1998.

The measurement method of the average reflectance R₅₋₂₅ is similar to the measurement method of an average emittance E₅₋₂₅ (described later) except that the spectral reflectances are measured for the wavelengths included in the wavelength range of 5 μm-25 μm in Appendix Table 3 in JIS R 3106:1998 and the arithmetic mean value of the measurement results is obtained.

The material of the internal far-infrared reflecting film may be, for example, aluminum, an aluminum alloy, silver, a silver alloy, copper, or a copper alloy.

### External Solar-Ray Reflecting Film

The radiative cooling device of the present disclosure may include an external solar-ray reflecting film that is arranged on an outer side of at least part of an outer wall surface of the vacuum heat insulating container and that reflects solar rays. With the configuration, generation of heat at the vacuum heat insulating container due to absorption of solar rays can be suppressed, and hence the radiative cooling effect by the radiative cooling device of the present disclosure can be further increased.

The word “external” of the external solar-ray reflecting film represents the exterior of the vacuum heat insulating container.

For the external solar-ray reflecting film, a layer similar to a solar-ray reflecting layer that may be included in a far-infrared transmitting window member (described later) (preferably, a solar-ray reflecting layer being a resin layer including gas cells) can be used.

### Far-Infrared Radiator

The radiative cooling device of the present disclosure includes a far-infrared radiator (for example, the above-described far-infrared radiator 30) that radiates specific far-infrared rays in the vacuum heat insulating container.

When the object is housed in the vacuum heat insulating container, the far-infrared radiator is arranged between the object and the opening portion of the vacuum heat insulating container and thermally contacts the object.

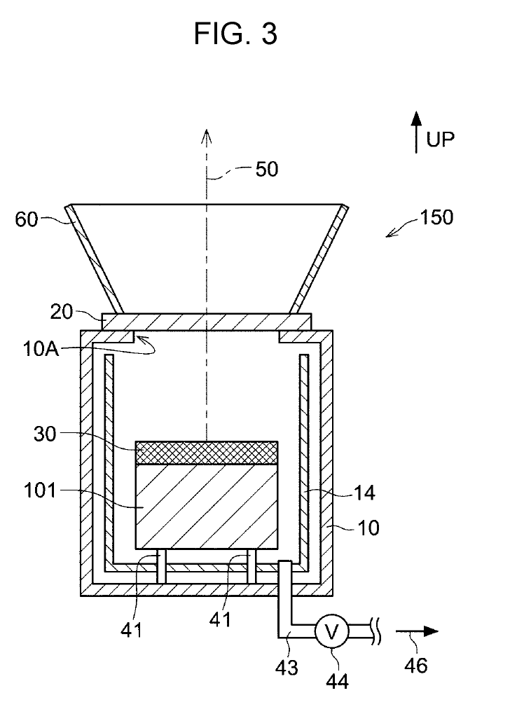

In this specification, “to radiate specific far-infrared rays” represents that an average emittance E₈₋₁₃ in a wavelength range of 8-13 μm in a radiation direction of the specific far-infrared rays is 0.40 or more. The radiation direction of the specific far-infrared rays is a direction in which the specific far-infrared rays radiated from the far-infrared radiator are dissipated to the outside from the vacuum heat insulating container via the far-infrared transmitting window member, and is, for example, a direction indicated as a traveling direction of the specific far-infrared rays 50 in FIGS. 1 and 3.

The position of the far-infrared radiator in the vacuum heat insulating container is preferably a position at which at least part of the opening portion overlaps at least part of the far-infrared radiator, or more preferably a position at which the entirety of the opening portion overlaps at least part of the far-infrared radiator, in plan view of the opening portion of the vacuum heat insulating container from the outside of the vacuum heat insulating container.

The structure of the far-infrared radiator may be a single-layer structure consisting of a radiator main body, or may be a multilayer structure including the radiator main body and another layer (for example, a radiator reflecting layer (described later)).

Average Emittance E₈₋₁₃ in Wavelength Range of 8 μm-13 μm

The far-infrared radiator has an average emittance E₈₋₁₃ in the wavelength range of 8 μm-13 μm in the radiation direction of the specific far-infrared rays, the average emittance E₈₋₁₃ being preferably 0.80 or more, more preferably 0.85 or more, or particularly preferably 0.90 or more. If the average emittance E₈₋₁₃ of the far-infrared radiator is 0.80 or more, the radiation performance of the specific far-infrared rays of the far-infrared radiator is further improved, and hence the attainable temperature at cooling can be further decreased.

The upper limit of the average emittance E₈₋₁₃ of the far-infrared transmitting window member is not particularly limited. The average emittance E₈₋₁₃ is preferably 0.98 or less in a viewpoint of suitability for manufacturing of the far-infrared transmitting window member.

In this specification, when the far-infrared radiator has a multilayer structure, the preferable spectral characteristics (average emittance) of the far-infrared radiator represent the spectral characteristics of the entire far-infrared radiator (that is, the entire multilayer structure).

In this specification, the average emittance E₈₋₁₃ represents an arithmetic mean value of spectral emittances obtained from spectral transmittances and spectral reflectances according to the Kirchhoff theory for wavelengths (10 wavelengths described below) included in a wavelength range of 8 μm-13 μm in Appendix Table 3 in JIS R 3106:1998.

The average emittance in the wavelength range of 8 μm-13 μm is specifically obtained as follows.

First, spectral transmittances and spectral reflectances in a wavelength range of 1.7 μm-25 μm are measured by using a Fourier transform infrared spectrometer (FTIR).

Among the measurement results of the spectral transmittances and spectral reflectances in the wavelength range of 1.7 μm-25 μm, a spectral emittance is calculated according to the Kirchhoff theory written below for each of the wavelengths included in the wavelength range of 8 μm-13 μm (more specifically, 10 wavelengths of 8.1 μm, 8.6 μm, 9.2 μm, 9.7 μm, 10.2 μm, 10.7 μm, 11.3 μm, 11.8 μm, 12.4 μm, and 12.9 μm) in Appendix Table 3 in JIS R 3106:1998.

Kirchhoff theory: spectral emittance=1-spectral transmittance-spectral reflectance

By arithmetically averaging the spectral emittances of the respective wavelengths (10 values), “the average emittance in the wavelength range of 8 μm-13 μm” is obtained.

In an example (described later), for the FTIR device, a FTIR (model No. FTS-7000) manufactured by Varian, Inc. was used.

E₈₋₁₃/E₅₋₂₅ Ratio

The far-infrared radiator preferably radiates the specific far-infrared rays with priority (or ideally, selectively) in the radiation direction of the specific far-infrared rays.

More specifically, an E₈₋₁₃/E₅₋₂₅ ratio that is a ratio of the average emittance E₈₋₁₃ of the far-infrared radiator to an average emittance E₅₋₂₅ of the far-infrared radiator in a wavelength range of 5 μm-25 μm in the radiation direction of the specific far-infrared rays is preferably 1.20 or more, more preferably 1.30 or more, or particularly preferably 1.50 or more.

If the E₈₋₁₃/E₅₋₂₅ ratio of the far-infrared radiator is 1.20 or more, the specific far-infrared rays can be radiated from the far-infrared radiator while heat inflow to the far-infrared radiator due to heat radiation of the atmosphere (that is, heat radiation caused by electromagnetic waves with wavelengths of less than 8 μm and electromagnetic waves with wavelengths of more than 13 μm) is suppressed. Thus, the attainable temperature at cooling can be further decreased.

The upper limit of the E₈₋₁₃/E₅₋₂₅ ratio is not particularly limited. The upper limit of the E₈₋₁₃/E₅₋₂₅ ratio is preferably 2.40 or less in a viewpoint of suitability for manufacturing of the far-infrared radiator.

In this specification, the average emittance E₅₋₂₅ represents an arithmetic mean value of spectral emittances for wavelengths included in a wavelength range of 5 μm-25 μm in Appendix Table 3 in JIS R 3106:1998.

The average emittance E₅₋₂₅ is specifically obtained as follows.

First, spectral transmittances and spectral reflectances in a wavelength range of 1.7 μm-25 μm are measured by using a Fourier transform infrared spectrometer (FTIR).

Among the measurement results of the spectral transmittances and spectral reflectances in the wavelength range of 1.7 μm-25 μm, the spectral emittance is calculated according to the Kirchhoff theory written above for each of the wavelengths included in the wavelength range of 5 μm-25 μm (more specifically, 24 wavelengths of 5.5 μm, 6.7 μm, 7.4 μm, 8.1 μm, 8.6 μm, 9.2 μm, 9.7 μm, 10.2 μm, 10.7 μm, 11.3 μm, 11.8 μm, 12.4 μm, 12.9 μm, 13.5 μm, 14.2 μm, 14.8 μm, 15.6 μm, 16.3 μm, 17.2 μm, 18.1 μm, 19.2 μm, 20.3 μm, 21.7 μm, and 23.3 μm) in Appendix Table 3 in JIS R 3106:1998.

By arithmetically averaging the spectral emittances of the respective wavelengths (24 values), the average emittance E₅₋₂₅ is obtained.

### Average Reflectance R₃₋₇ in Wavelength Range of 3 μm-7 μm

The far-infrared radiator has, at a surface thereof on a side of a far-infrared transmitting window member, an average reflectance R₃₋₇ in a wavelength range of 3 μm-7 μm, the average reflectance R₃₋₇ being preferably 0.05 or more, or more preferably 0.10 or more. If the average reflectance R₃₋₇ of the far-infrared transmitting window member is 0.10 or more, incidence of electromagnetic waves in a wavelength range of 3 μm-7 μm from an upper side to the far-infrared radiator and the object (a direction of the far-infrared transmitting window member when viewed from the far-infrared radiator) can be suppressed, and hence an increase in the attainable temperature due to the incidence of the electromagnetic waves can be further suppressed.

The average reflectance R₃₋₇ being 0.05 or more can be easily attained when the far-infrared radiator includes a radiator reflecting layer (described later).

The upper limit of the average reflectance R₃₋₇ of the far-infrared transmitting window member is not particularly limited. The average reflectance R₃₋₇ of the far-infrared transmitting window member is preferably 0.90 or less (or more preferably 0.80 or less) in a viewpoint of suitability for manufacturing of the far-infrared transmitting window member.

In this specification, the average reflectance R₃₋₇ represents an arithmetic mean value of spectral reflectances for wavelengths included in a wavelength range of 3 μm-7 μm in Appendix Table 3 in JIS R 3106:1998.

The measurement method of the average reflectance R₃₋₇ is similar to the measurement method of the average emittance E₈₋₁₃ (described above) except that the spectral reflectances are measured for the wavelengths included in the wavelength range of 3 μm-7 μm in Appendix Table 3 in JIS R 3106:1998 and the arithmetic mean value of the measurement results is obtained.

### Materials and Shapes

The far-infrared radiator (radiator main body) can appropriately select and use a substance that radiates specific far-infrared rays from known heat radiators, and is not particularly limited.

The far-infrared radiator (radiator main body) is preferably a blackbody radiator or a radiator including a multilayer film of a titania film and a silica film in a viewpoint of high average emittance in a wavelength range of 8 μm-13 μm.

The far-infrared radiator (radiator main body) is preferably a blackbody radiator in a viewpoint of easy manufacturing.

The blackbody radiator may be, for example, a blackbody radiator being a blackbody, a blackbody radiator formed by applying a coating to a surface of a metal material using a commercially available blackbody spray, or a blackbody radiator to which a commercially available blackbody tape is attached to a surface of a metal material.

The far-infrared radiator (radiator main body) is preferably a radiator including a multilayer film of a titania film and a silica film in a viewpoint of easily improving the E₈₋₁₃/E₅₋₂₅ ratio (for example, a viewpoint of easily achieving that the E₈₋₁₃/E₅₋₂₅ ratio is 1.20 or more).

The three-dimensional shape of the entire far-infrared radiator is not particularly limited; however, the shape is preferably a plate shape in a viewpoint of reducing the size of the device.

The shape in plan view of the entire far-infrared radiator is not particularly limited. The shape in plan view of the entire far-infrared radiator may be an elliptic shape (including a circular shape), a rectangular shape (including a square shape), or a polygonal shape other than the rectangular shape. The shape in plan view of the far-infrared radiator may be an indeterminate shape other than the above-listed shapes.

The shape in plan view of the entire far-infrared radiator is preferably an elliptic shape or more preferably a circular shape in a viewpoint of availability.

The thickness of the entire far-infrared radiator is not particularly limited.

The thickness of the entire far-infrared radiator is preferably 1 mm-30 mm, more preferably 1 mm-20 mm, or particularly preferably 2 mm-10 mm.

If the thickness of the entire far-infrared radiator is 1 mm or more, this is advantageous for the strength of the far-infrared radiator.

If the thickness of the entire far-infrared radiator is 30 mm or less, this is advantageous for saving the space in the heat insulating container.

### Radiator Reflecting Layer

The far-infrared radiator may include a radiator main body, and a radiator reflecting layer that is arranged on a side of the far-infrared transmitting window member when viewed from the radiator main body and that reflects electromagnetic waves in a wavelength range of 3 μm-7 μm.

With the aspect in which the far-infrared radiator includes the radiator reflecting layer, incidence of the electromagnetic waves in the wavelength range of 3 μm-7 μm from an upper side (a direction of the far-infrared transmitting window member when viewed from the far-infrared radiator) to the radiator main body and the object can be suppressed, and hence an increase in the attainable temperature due to the incidence of the electromagnetic waves can be further suppressed.

A preferable aspect of the radiator reflecting layer is similar to a preferable aspect of a solar-ray reflecting layer (described later).

With the aspect in which the far-infrared radiator includes the radiator reflecting layer, the average reflectance R₃₋₇ of the far-infrared radiator being 0.05 or more is further easily achieved.

### Far-Infrared Transmitting Window Member

The radiative cooling device of the present disclosure includes a far-infrared transmitting window member (for example, the above-described far-infrared transmitting window member 20) that closes the opening portion of the vacuum heat insulating container and transmits the specific far-infrared rays (that is, far-infrared rays in a wavelength range of 8 μm-13 μm).

The structure of the far-infrared transmitting window member may be a single-layer structure consisting of a window-member main body, or may be a multilayer structure including the window-member main body and another layer (for example, a solar-ray reflecting layer (described later)).

Average Transmittance T₈₋₁₃ in Wavelength Range of 8 μm-13 μm

The far-infrared transmitting window member has an average transmittance T₈₋₁₃ in a wavelength range of 8 μm-13 μm in a transmission direction of the specific far-infrared rays, the average transmittance T₈₋₁₃ being preferably 0.40 or more, more preferably 0.50 or more, or particularly preferably 0.60 or more. The transmission direction of the specific far-infrared rays is a direction in which the specific far-infrared rays radiated from the far-infrared radiator are dissipated to the outside from the vacuum heat insulating container via the far-infrared transmitting window member, and is, for example, a direction indicated as a traveling direction of the specific far-infrared rays 50 in FIGS. 1 and 3.

If the average transmittance T₈₋₁₃ of the far-infrared transmitting window member is 0.40 or more, the far-infrared transmitting window member more easily transmits the specific far-infrared rays radiated from the far-infrared radiator, and hence the attainable temperature at cooling can be further decreased.

The upper limit of the average transmittance T₈₋₁₃ of the far-infrared transmitting window member is not particularly limited. The average transmittance T₈₋₁₃ of the far-infrared transmitting window member is preferably 0.98 or less in a viewpoint of suitability for manufacturing of the far-infrared transmitting window member.

In this specification, when the far-infrared transmitting window member has a multilayer structure, the preferable spectral characteristics (average transmittance and solar-radiation reflectance) of the far-infrared transmitting window member represent the spectral characteristics of the entire far-infrared transmitting window member (that is, the entire multilayer structure).

In this specification, the average transmittance T₈₋₁₃ represents an arithmetic mean value of spectral transmittances for wavelengths included in a wavelength range of 8 μm-13 μm in Appendix Table 3 in JIS R 3106:1998.

The average transmittance T₈₋₁₃ is specifically obtained as follows.

First, spectral transmittances in a wavelength range of 1.7 μm-25 μm are measured by using a Fourier transform infrared spectrometer (FTIR).

Among the measurement results of the spectral transmittances in the wavelength range of 1.7 μm-25 μm, by arithmetically averaging the values (that is, 10 values) of the spectral transmittances of the respective wavelengths (the above-described 10 wavelengths) included in the wavelength range of 8 μm-13 μm in Appendix Table 3 in JIS R 3106:1998, the average transmittance T₈₋₁₃ is obtained.

T₈₋₁₃/T₅₋₂₅ Ratio

The far-infrared transmitting window member preferably transmits the specific far-infrared rays with priority (or ideally, selectively) in the transmission direction of the specific far-infrared rays.

More specifically, a T₈₋₁₃/T₅₋₂₅ ratio that is a ratio of the above-described average transmittance T₈₋₁₃ of the far-infrared transmitting window member to an average transmittance T₅₋₂₅ of the far-infrared transmitting window member in a wavelength range of 5 μm-25 μm in the transmission direction of the specific far-infrared rays is preferably 1.20 or more, more preferably 1.30 or more, or particularly preferably 1.50 or more.

If the T₈₋₁₃/T₅₋₂₅ ratio of the far-infrared transmitting window member is 1.20 or more, the specific far-infrared rays from the far-infrared radiator can be transmitted while heat inflow into the radiative cooling device due to heat radiation of the atmosphere (that is, heat radiation caused by electromagnetic waves with wavelengths of less than 8 μm and electromagnetic waves with wavelengths of more than 13 μm) is suppressed. Thus, the attainable temperature at cooling can be further decreased.

The upper limit of the T₈₋₁₃/T₅₋₂₅ ratio is not particularly limited. The upper limit of the T₈₋₁₃/T₅₋₂₅ ratio is preferably 2.40 or less in a viewpoint of suitability for manufacturing of the far-infrared transmitting window member.

In this specification, the average transmittance T₅₋₂₅ represents an arithmetic mean value of spectral transmittances for wavelengths included in a wavelength range of 5 μm-25 μm in Appendix Table 3 in JIS R 3106:1998.

The average transmittance T₅₋₂₅ is specifically obtained as follows.

First, spectral transmittances in a wavelength range of 1.7 μm-25 μm are measured by using a Fourier transform infrared spectrometer (FTIR).

Among the measurement results of the spectral transmittances in the wavelength range of 1.7 μm-25 μm, by arithmetically averaging values of the spectral transmittances (that is, 24 values) of the respective wavelengths (that is, the above-described 24 wavelengths) included in the wavelength range of 5 μm-25 μm in Appendix Table 3 in JIS R 3106:1998, the average transmittance T₅₋₂₅ is obtained.

### Solar-Radiation Reflectance

The far-infrared transmitting window member preferably has, at a surface thereof on a side opposite to a surface thereof on a side of the far-infrared radiator, a solar-radiation reflectance of 60% or more.

If the solar-radiation reflectance of the far-infrared transmitting window member is 60% or more, incidence of solar rays (that is, electromagnetic waves in a wavelength range of 300 nm-2500 nm) into the heat insulating container can be suppressed, and hence heat inflow into the heat insulating container can be suppressed. Thus, the attainable temperature at cooling can be further decreased.

The solar-radiation reflectance of the far-infrared transmitting window member is preferably 70% or more, or more preferably 80% or more.

The upper limit of the solar-radiation reflectance of the far-infrared transmitting window member is not particularly limited. The solar-radiation reflectance of the far-infrared transmitting window member is preferably 98% or less in a viewpoint of suitability for manufacturing of the far-infrared transmitting window member.

The solar-radiation reflectance of the far-infrared transmitting window member being 60% or more can be more easily attained when the far-infrared transmitting window member includes a solar-ray reflecting layer (described later).

In this specification, the solar-radiation reflectance complies with JIS A 5759:2008, and represents a value obtained by measuring a diffused reflectance using a spectrophotometer and calculating the value based on the obtained diffused reflectance.

For the spectrophotometer, an integrating-sphere spectrophotometer may be used.

In an example (described later), for the spectrophotometer to be used for measuring the solar-radiation reflectance, a spectrophotometer V-670 (integrating-sphere spectrophotometer) manufactured by JASCO Corporation was used.

### Materials and Shapes

The material of the far-infrared transmitting window member (window-member main body) is not particularly limited as long as the material can transmit the specific far-infrared rays.

The material of the far-infrared transmitting window member (window-member main body) may be a metal material or an inorganic material other than the metal material, or more specifically may be germanium (Ge, transmission wavelength: 1.8 μm-23 μm), chalcogenide (transmission wavelength: 0.75 μm-14 μm), silicon (Si, transmission wavelength: 1.2 μm-15 μm), diamond (transmission wavelength: 220 nm or more), calcium fluoride (CaF₂, transmission wavelength: 0.12 μm-12 μm), zinc selenide (ZnSe, transmission wavelength: 0.5 μm-22 μm), barium fluoride (BaF₂, transmission wavelength: 0.15 μm-15 μm), or zinc sulfide (ZnS, transmission wavelength: 0.37 μm-14 μm).

In particular, germanium, chalcogenide, or silicon is preferable among these materials.

The far-infrared transmitting window member may be treated with an antireflection coating.

The three-dimensional shape of the entire far-infrared transmitting window member is not particularly limited.

The three-dimensional shape of the far-infrared transmitting window member is preferably a plate shape in a viewpoint of easy fabrication.

The shape in plan view of the entire far-infrared transmitting window member is not particularly limited. The shape in plan view of the entire far-infrared transmitting window member may be an elliptic shape (including a circular shape), a rectangular shape (including a square shape), or a polygonal shape other than the rectangular shape. The shape in plan view of the far-infrared transmitting window member may be an indeterminate shape other than the above-listed shapes.

The thickness of the entire far-infrared transmitting window member is not particularly limited.

The thickness of the entire far-infrared transmitting window member is preferably 1 mm-30 mm, more preferably 1 mm-20 mm, or particularly preferably 2 mm-10 mm.

If the thickness is 1 mm or more, entry of electromagnetic waves other than the specific far-infrared rays into the heat insulating container can be further suppressed, and the thickness is advantageous in a viewpoint of the strength of the far-infrared transmitting window member.

If the thickness is 30 mm or less, the transmittance of the specific far-infrared rays is further improved.

### Solar-Ray Reflecting Layer

The far-infrared transmitting window member may include a window-member main body, and a solar-ray reflecting layer that is arranged on a side opposite to a side of the far-infrared radiator when viewed from the window-member main body and that reflects solar rays.

With the aspect in which the far-infrared transmitting window member includes the solar-ray reflecting layer, incidence of solar rays (that is, electromagnetic waves in a wavelength range of 0.3 μm-2.5 μm) into the heat insulating container can be suppressed, and hence heat inflow into the heat insulating container can be suppressed. Thus, the attainable temperature at cooling can be further decreased.

With the aspect in which the far-infrared transmitting window member includes the solar-ray reflecting layer, the solar-radiation reflectance of the far-infrared transmitting window member being 60% or more (preferably, 70% or more, or further preferably, 80% or more) is further easily achieved.

The solar-ray reflecting layer has a function of reflecting solar rays; however, may have a function of reflecting electromagnetic waves (for example, electromagnetic waves with wavelengths being more than 2.5 μm and less than 8 μm) other than solar rays.

The structure, size, material, and so forth, of the solar-ray reflecting layer are not particularly limited, and may be appropriately selected depending on the purpose.

The structure of the solar-ray reflecting layer may be a single-layer structure or a multilayer structure.

If the structure of the solar-ray reflecting layer is a multilayer structure, the multilayer structure preferably has at least one layer selected from the group consisting of a metal layer, an inorganic layer, and an organic layer.

The structure of the solar-ray reflecting layer may include a microstructure (particles, gas cells, etc.), or may have a protruded and depressed structure at a surface thereof.

When the structure of the solar-ray reflecting layer includes a microstructure, “the microstructure” may be particles, gas cells, or the like.

The solar-ray reflecting layer is not limited to a continuous layer, and may be a particle layer consisting of particles dispersed into the window-member main body.

The solar-ray reflecting layer preferably contains particles.

The particles preferably have a number-average particle diameter of 0.1 μm-20 μm.

If the number-average particle diameter of the particles is 0.1 μm or more, a scattering cross-sectional area of the solar-ray reflecting layer for solar rays increases. Thus, the solar-radiation reflectance of the entire far-infrared transmitting window member can be increased.

If the number-average particle diameter of the particles is 20 μm or less, the scattering cross-sectional area of the solar-ray reflecting layer for the specific far-infrared rays decreases. Thus, the transmittance of the entire far-infrared transmitting window member for the specific far-infrared rays can be maintained high.

The number-average particle diameter of the particles represents a value measured as follows.

That is, the solar-ray reflecting layer is cut along a thickness direction thereof using a microtome, and a cross-sectional image with a 1000-fold magnification is acquired from the cut surface using an electron microscope S4100 (manufactured by Hitachi High-Technologies Corporation). In the acquired cross-sectional image, for each particle, it is assumed that the maximum length among segments that each connect two points in the particle is a particle length.

The measurement for the particle length is performed at 100 positions in the cross-sectional image, an average value of the 100 measurement values is obtained, and the average value serves as the number-average particle diameter of the particles.

The substance forming the particles may be, for example, a titanium oxide, a barium titanate compound, zinc sulfide, a barium oxide, a magnesium oxide, or a calcium oxide. In particular, zinc sulfide is preferable among these materials in a viewpoint of having good optical characteristics.

When the solar-ray reflecting layer contains particles, the solar-ray reflecting layer may contain resin.

Specific examples of the resin are similar to specific examples of resin in a resin layer including gas cells (described later).

The solar-ray reflecting layer is preferably a particle layer consisting of particles dispersed in the window-member main body (for example, the above-described zinc sulfide particles or titanium oxide particles) in a viewpoint that the entire far-infrared transmitting window member maintains transmissivity for the specific far-infrared rays.

If the solar-ray reflecting layer includes gas cells as a microstructure, the material of part other than gas cells may be resin.

That is, for the solar-ray reflecting layer, a solar-ray reflecting layer that is a resin layer including gas cells may be used.

The resin in the resin layer including gas cells may be polyolefin (for example, polyethylene, polypropylene, poly-4-methylpentene-1, polybutene-1, etc.), polyester (for example, polyethylene terephthalate, polyethylene naphthalate, etc.), polycarbonate, polyvinyl chloride, polyphenylene sulfide, polyethersulfone, polyethylene sulfide, polyphenylene ether, polystyrene, acrylic resin, polyamide, polyimide, or cellulose (for example, cellulose acetate).

The resin is preferably polyester or polyethylene terephthalate (hereinafter, also referred to as “PET”) in a viewpoint of having good workability and good optical characteristics.

The resin layer including gas cells may include a mixture of two or more types of resin depending on the purpose.

The resin layer including gas cells may contain unavoidable impurities to a certain extent that does not affect the reflectance for solar rays.

A gas cell in the resin layer including gas cells is a space consisting of a gas and having a gas-cell length in the resin being 10 nm or more. For each gas cell, the gas-cell length is the maximum length among segments that each connect two points in the gas cell. The gas-cell length is a value measured by a method (described later).

The type of gas may be the air, or may be any type of gas other than the air, such as oxygen, nitrogen, or carbon dioxide.

The shape of the gas cell is not particularly limited, and may be any type of shape, such as a spherical shape, a columnar shape, an elliptic shape, a rectangular-parallelepiped shape (cube shape), or a prism shape.

The pressure of gas may be the atmospheric pressure, or the pressure may be increased or reduced as compared with the atmospheric pressure. The gas cells may exist separately or in a partly connected manner.

The gas cells have a number-average length of preferably 0.1 μm-20 μm.

If the number-average length of the gas cells is 0.1 μm or more, a scattering cross-sectional area of the solar-ray reflecting layer for solar rays increases. Thus, the solar-radiation reflectance of the far-infrared transmitting window member can be increased.

If the number-average length of the gas cells is 20 μm or less, the scattering cross-sectional area of the solar-ray reflecting layer for specific far-infrared rays decreases. Thus, the transmittance of the far-infrared transmitting window member for the specific far-infrared rays can be maintained high.

The number-average length of the gas cells represents a value measured as follows.

In a cross-sectional image acquired similarly to the measurement for the number-average particle diameter of the particles, for each gas cell, it is assumed that the maximum length among segments that each connect two points in the gas cell is a gas-cell length.

The measurement for the gas-cell length is performed for 100 gas cells in the cross-sectional image, an average value of the 100 measurement values is obtained, and the average value serves as the number-average length of the gas cells.

For the solar-ray reflecting layer that is the resin layer including the gas cells, a commercially available resin film may be used.

A commercially available product of the resin film may be a microcellular foamed reflector “MCPET/MCPOLYCA” manufactured by Furukawa Electric Co., Ltd., or a Lumirror (registered trademark) E20, E22, E28G, or E60 that is a white PET film manufactured by Toray Industries, Inc.

When the structure of the solar-ray reflecting layer has a protruded and depressed structure at a surface thereof, the protruded and depressed structure may have an average pitch of 100 μm or less.

Means for forming such a protruded and depressed structure may be, for example, nanoimprinting or plasma etching.

### Metal Cylindrical Member

The radiative cooling device of the present disclosure may include a metal cylindrical member that is arranged on a side opposite to a side of the far-infrared radiator when viewed from the far-infrared transmitting window member and through which the specific far-infrared rays transmitted through the far-infrared transmitting window member pass.

If the radiative cooling device of the present disclosure includes the metal cylindrical member, heat inflow into the vacuum heat insulating container due to heat radiation from a peripheral environmental member (for example, a structure, such as a building or a utility pole) can be suppressed. Thus, a decrease in radiative cooling performance due to the heat inflow can be further suppressed.

In this case, “cylinder” is a concept including a tapered cylinder.

The tapered cylinder is a cylinder having a shape whose diameter (outside diameter and inside diameter) increases from a side of one end toward a side of the other end in an axial direction thereof.

FIG. 3 is a schematic cross-sectional view showing a radiative cooling device including a metal cylindrical member according to another example of the radiative cooling device of the present disclosure.

A radiative cooling device 150 shown in FIG. 3 has a structure similar to the structure of the radiative cooling device 100 shown in FIG. 1 except that the structure of the radiative cooling device 150 includes a metal cylindrical member 60.

As shown in FIG. 3, the radiative cooling device 150 includes the metal cylindrical member 60 that is arranged on a side opposite to a side of the far-infrared radiator 30 when viewed from the far-infrared transmitting window member 20.

The metal cylindrical member 60 has a tapered cylindrical shape. The tapered cylindrical shape may be, for example, a linear tapered shape, a parabolic tapered shape, or an exponential tapered shape.

The metal cylindrical member 60 is arranged such that one end thereof in an axial direction thereof contacts the far-infrared transmitting window member 20, and in a direction in which a diameter thereof increases from one end toward the other end in the axial direction.

Furthermore, the metal cylindrical member 60 is arranged so as to include the opening portion 10A in a range surrounded by an inner peripheral surface thereof on a side of the one end of the metal cylindrical member 60 in plan view (not shown) viewed in an opening direction of the opening portion 10A.

With the radiative cooling device 150, the specific far-infrared rays 50 transmitted through the far-infrared transmitting window member 20 pass through the inside of the metal cylindrical member 60, and heat radiation from a peripheral environmental member (for example, a structure, such as a building or a utility pole) (more specifically, far-infrared rays radiated from the peripheral environment member) can be blocked using an outer peripheral surface of the metal cylindrical member 60.

Furthermore, since the metal cylindrical member 60 is arranged in the direction in which the diameter increases from the one end toward the other end in the axial direction, the effective area in which the specific far-infrared rays 50 are radiated becomes larger than the area of the opening portion 10A.

Thus, the radiative cooling device 150 can obtain better radiative cooling performance.

An opening area on a side of the other end (that is, at an end portion on a far side when viewed from the far-infrared transmitting window member 20) of the metal cylindrical member 60 in the axial direction is preferably 1.1 times or more, or more preferably 1.3 times or more the area of the opening portion 10A in a viewpoint of increasing the effective area in which the specific far-infrared rays 50 are radiated.

The opening area on the side of the other end of the metal cylindrical member 60 in the axial direction is preferably 6.0 times or less, or more preferably 5.0 times or less the area of the opening portion 10A in a viewpoint of effectively blocking heat radiation from the peripheral environmental member.

The material (metal) of the surface of the metal cylindrical member is preferably a metal with high reflectance for far-infrared rays. More specifically, the material is preferably aluminum, an aluminum alloy, silver, or a silver alloy.

For the metal cylindrical member, a commercially available parabolic mirror (for example, a parabolic mirror manufactured by Kokusai Shoji Co., Ltd.) may be used.

The parabolic mirror (parabolic surface mirror) is a metal cylindrical member having a parabolic tapered shape.

The size of the metal cylindrical member is not particularly limited, and may be appropriately set with regard to the purpose and so forth of the radiative cooling device.

The shapes of opening portions at both ends of the metal cylindrical member in an axial direction thereof are preferably circular shapes.

### Angle Changing Device of Metal Cylindrical Member

When the radiative cooling device of the present disclosure includes the above-described metal cylindrical member, the radiative cooling device of the present disclosure may include an angle changing device that changes an angle at which an outer opening portion of the metal cylindrical member (an end portion on a far side when viewed from the far-infrared transmitting window member) faces.

The outer opening portion of the metal cylindrical member is an opening portion at the end portion on the far side when viewed from the far-infrared transmitting window member.

The angle changing device preferably has a function of causing the outer opening portion of the metal cylindrical member to face in a direction different from the position of the sun. To attain such a function, a certain system may be appropriately selected and applied.

With the function, the angle changing device causes the outer opening portion of the metal cylindrical member to face in the direction different from the position of the sun. Thus, direct incidence of solar rays can be suppressed, and heat inflow due to the incidence can be suppressed. Accordingly, an increase in the attainable temperature can be further suppressed particularly during the daytime.

### EXAMPLES

Examples of the present disclosure are described below; however, the present disclosure is not limited to the examples provided below.

### Example 1

### Fabrication of Radiative Cooling Device

In Example 1, a radiative cooling device 100 shown in FIG. 1 was fabricated.

First, a vacuum heat insulating container 10 made of SUS304 and having a shape provided with an opening portion 10A at an upper surface of a hollow columnar shape was prepared. The hollow columnar shape had an inside diameter of 200 mm, an outside diameter of 220 mm, and a height of 168 mm. The opening portion 10A had a diameter of 140 mm. One end of a pipe 43 including a valve 44 is connected to the vacuum heat insulating container 10. A vacuum gauge (G-TRAN SW1 manufactured by ULVAC, Inc., not shown) for checking the degree of vacuum in the vacuum heat insulating container 10, and a vacuum pump (GVD-136 manufactured by ULVAC, Inc., not shown) for forming a vacuum in the vacuum heat insulating container 10 are connected in series to the other end of the pipe 43 in that order from the side of the above-described other end.

In evaluation on radiative cooling performance (described later), the degree of vacuum in the vacuum heat insulating container 10 was obtained by measuring the voltage of the vacuum gauge using a high-performance recorder (GR-3500 manufactured by KEYENCE Corporation) and converting the numerical value into the degree of vacuum.

Three support pins 41 for supporting an object to be cooled were arranged on a bottom surface in the vacuum heat insulating container 10. For the three support pins 41, hex socket set screws MSST6-25 (length: 25 mm, diameter: 6 mm, manufactured by MISUMI Corporation) were used.

For an internal far-infrared reflecting film 14, a commercially available aluminum foil (foil manufactured by Mitsubishi Aluminum Co., Ltd.) was arranged in the vacuum heat insulating container 10 along an inner wall surface of the vacuum heat insulating container 10.

For an object to be cooled 101, a plate material made of stainless steel (SUS304) with a heat capacity of 1500 J/K, a diameter of 140 mm, and a thickness of 21 mm was prepared.

A T-type thermocouple for temperature measurement (manufactured by Hakko Electric Co., Ltd.) was attached to a surface of the object 101.

A far-infrared radiator 30 was prepared by applying a blackbody coating (blackbody paint JSC-3, manufactured by Japan Sensor Corporation) to a surface of an aluminum disk plate with a diameter of 140 mm, a thickness of 5 mm, and a heat capacity of 350 J/K, and drying the coating.

For a far-infrared transmitting window member 20, a germanium plate with a diameter of 160 mm and a thickness of 5 mm (manufactured by IR System Co., Ltd.) whose both surfaces were coated with DLC (diamond like carbon) was prepared.

The spectral characteristics of the far-infrared transmitting window member 20 and the far-infrared radiator 30 were as shown in Table 1.

By using the respective members prepared as described above, a radiative cooling device 100 was fabricated.

First, the object 101 was inserted into the vacuum heat insulating container 10 in which the internal far-infrared reflecting film 14 and the three support pins 41 were arranged, and the object 101 was placed on the three support pins 41. In this case, the shortest distance (L in inequality (1)) between the vacuum heat insulating container 10 and the object 101 was set to 0.015 m.

Then, the far-infrared radiator 30 was inserted into the vacuum heat insulating container 10, and placed on the object 101.

Then, the entire opening portion 10A of the vacuum heat insulating container 10 was covered with the far-infrared transmitting window member 20, the far-infrared transmitting window member 20 was fixed, and hence the opening portion 10A was closed with the far-infrared transmitting window member 20.

Thus, the radiative cooling device 100 was obtained.

### Evaluation on Radiative Cooling Performance

The radiative cooling device 100 fabricated as described above was installed outdoors at an arrangement angle at which the opening portion 10A of the vacuum heat insulating container 10 faces directly upward.

For the outdoor arrangement location of the radiative cooling device 100, a location without an object that blocks the specific far-infrared rays 50 radiated from the far-infrared radiator 30 toward the sky was selected.

For the evaluation environment, the nighttime on a fine day (outside air temperature: 24° C.) was selected.

Sunset was set as the evaluation start time, and a vacuum pump was activated in a state where the valve 44 was open to form a vacuum in the vacuum heat insulating container 10 of the radiative cooling device 100 until the degree of vacuum becomes a degree of vacuum P shown in Table 1. Thus, the evaluation on radiative cooling performance was started.

After the start of the evaluation, the radiative cooling device 100 was situated at rest for 10 hours while the degree of vacuum in the vacuum heat insulating container 10 was adjusted to be maintained at the degree of vacuum P. During the evaluation, the temperature of the object 101 and the outside air temperature were measured. The temperature of the object 101 was observed using a T-type thermocouple (manufactured by Hakko Electric Co., Ltd.) attached to a surface of the object 101, and the outside air temperature was observed using a K-type thermocouple (ST-50, manufactured by RKC Instrument Inc.).

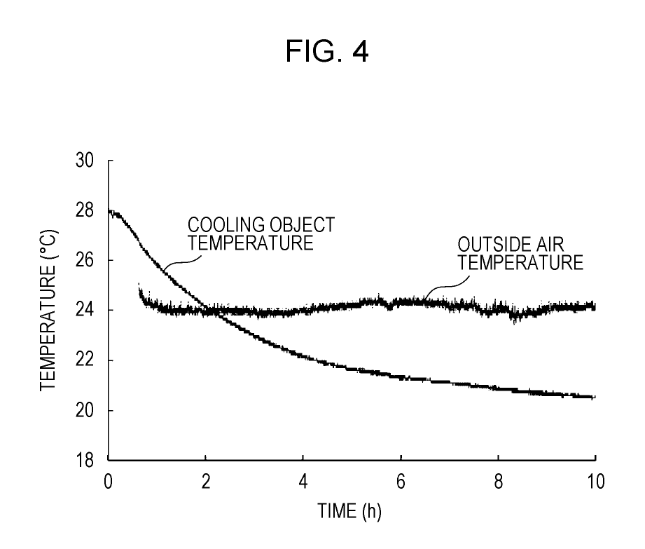

FIG. 4 is a graph showing the relationship between the time (horizontal axis: time (h)) that has elapsed since the start of the evaluation, and the temperature of the object and the outside air temperature (vertical axis: temperature (° C.)) in Example 1.

As shown in FIG. 4, it was recognized that the temperature of the object decreases (that is, the object is cooled) as the time elapses since the start of the evaluation.

After 10 hours has elapsed since the start of the evaluation, radiative cooling performance was evaluated by obtaining the temperature difference in the following expression (that is, the temperature of the object 101 with respect to the outside air temperature). The evaluation on radiative cooling performance represents that radiative cooling performance is higher as the temperature difference (° C.) is a negative value and the absolute value is larger.

Table 1 shows the result (temperature difference).

Temperature difference (° C.)=temperature of cooling object 101 (° C.)-outside air temperature (° C.)

### Example 2

In fabrication of a radiative cooling device 100, operations similar to those of Example 1 were performed except that the internal far-infrared reflecting film 14 was not used.

Table 1 shows the result.

### Example 3

Operations similar to those of Example 2 were performed except that the degree of vacuum P in the vacuum heat insulating container 10 in evaluation was changed to the value shown in Table 1.

Table 1 shows the result.

### Example 4

Operations similar to those of Example 2 were performed except that the far-infrared radiator 30 was changed to a far-infrared radiator having spectral characteristics shown in Table 1.

For the far-infrared radiator in Example 4, more specifically, a far-infrared radiator in which a multilayer film of a SiO₂ film and a TiO₂ film (to be specific, a multilayer film having a multilayer structure of a TiO₂ film, a SiO₂ film, and a TiO₂ film) was formed by sputtering on a surface of an aluminum disk plate with a diameter of 140 mm, a thickness of 5 mm, and a heat capacity of 350 J/K was used.

In Example 4, the multilayer structure of the far-infrared radiator and the film thicknesses of the respective films are a TiO₂ film (film thickness: 1463 nm), a SiO₂ film (film thickness: 643 nm), a TiO₂ film (film thickness: 1428 nm), and an Al substrate.

### Example 5

Operations similar to those of Example 2 were performed except that the far-infrared transmitting window member 20 was changed to a far-infrared transmitting window member having spectral characteristics shown in Table 1.

For the far-infrared transmitting window member in Example 5, more specifically, a far-infrared transmitting window member in which a solar-ray reflecting layer consisting of zinc sulfide particles was formed on a surface of the far-infrared transmitting window member used in Example 2 by dispersing zinc sulfide particles with a number-average particle diameter of 0.2 μm was used.

### Example 6

Operations similar to those of Example 2 were performed except that the far-infrared transmitting window member 20 was changed to a far-infrared transmitting window member having spectral characteristics shown in Table 1.

For the far-infrared transmitting window member in Example 6, more specifically, a far-infrared transmitting window member in which a multilayer film (to be specific, a multilayer film having a multilayer structure of a ZnS film, a Ge film, a TiO₂ film, a Ge film, and a ZnS film) was formed by sputtering on a surface of a Ge substrate was used. For the Ge substrate, a germanium plate (manufactured by IR System Co., Ltd.) with a diameter of 160 mm and a thickness of 5 mm having the same shape as the far-infrared transmitting window member in Example 2 was used.

The multilayer structure of the far-infrared transmitting window member and the film thicknesses of the respective films are a ZnS film (film thickness: 109 nm), a Ge film (film thickness: 322 nm), a TiO₂ film (film thickness: 600 nm), a Ge film (film thickness: 43 nm), a ZnS film (film thickness: 624 nm), and a Ge substrate.

### Example 7

In Example 7, a radiative cooling device 150 shown in FIG. 3 was fabricated.

More specifically, a parabolic mirror manufactured by Kokusai Shoji Co., Ltd. (to be more specific, a metal cylindrical member having a tapered cylindrical shape, the material of a surface thereof being aluminum (aluminum coating)) was attached as a metal cylindrical member 60 to a side of the far-infrared transmitting window member 20 of the radiative cooling device according to Example 2, the side being opposite to a side of a far-infrared radiator 30 when viewed from the far-infrared transmitting window member 20.

The parabolic mirror was attached such that one end thereof in an axial direction thereof contacts the far-infrared transmitting window member 20, and in a direction in which the diameter thereof increases from the one end toward the other end in the axial direction.

Moreover, the parabolic mirror was attached so as to include an opening portion 10A in a range surrounded by an inner peripheral surface on a side of one end of the metal cylindrical member 60 in plan view (not shown) viewed in an opening direction of the opening portion 10A.

An opening area on a side of the other end (that is, at an end portion on a far side when viewed from the far-infrared transmitting window member 20) of the parabolic mirror in the axial direction was 1.5 times the area of the opening portion 10A.

The above-described radiative cooling device 150 was used and evaluation similar to that in Example 2 was performed.

Table 1 shows the result.

### Comparative Example 1

In evaluation on radiative cooling performance, evaluation similar to that in Example 2 was performed except that a vacuum pump was not activated and the interior of the vacuum heat insulating container 10 was at the atmospheric pressure.

Table 1 shows the result.

### Comparative Example 2

In fabrication of a radiative cooling device, an operation similar to that of Example 2 was performed except that the far-infrared radiator 30 was changed to an aluminum circular disk before a blackbody coating was applied.

Table 1 shows the result.

The average emittance E₈₋₁₃ of the above-described aluminum circular disk was 0.05. As described above, the far-infrared radiator in this specification represents a radiator having an average emittance E₈₋₁₃ being 0.40 or more. The aluminum circular disk does not correspond to the far-infrared radiator according to this specification.

TABLE 1

| | | | Example 1 | Example 2 | Example 3 | Example 4 | Example 5 |
|---|---|---|---|---|---|---|---|
| Degree of vacuum P in | | Degree of vacuum P | 3 | 3 | 100 | 3 | 3 |
| vacuum heat insulating | | (Pa) | | | | | |
| container | | Inequality (1) | Y | Y | N | Y | Y |
| | | (Y: satisfied, | | | | | |
| | | N: not satisfied) | | | | | |
| | | λ(G)/λ(G, 0) ratio | 0.86 | 0.86 | 0.99 | 0.86 | 0.86 |
| Internal far-infrared reflecting film | | | Y | N | N | N | N |
| (Y: provided, N: not provided) | | | | | | | |
| Radiative | Far-infrared | Average | 0.76 | 0.76 | 0.76 | 0.76 | 0.66 |
| cooling | transmitting | transmittance T₈₋₁₃ | | | | | |
| device | window | T₈₋₁₃/T₅₋₂₅ ratio | 1.35 | 1.35 | 1.35 | 1.35 | 1.43 |
| | member | Solar-ray reflecting | N | N | N | N | Y |
| | | layer (Y: provided, N: | | | | | |
| | | not provided) | | | | | |
| | | Solar-radiation | 25% | 25% | 25% | 25% | 85% |
| | | reflectance | | | | | |
| | Far-infrared | Average emittance | 0.94 | 0.94 | 0.94 | 0.80 | 0.94 |
| | radiator | E₈₋₁₃ | | | | | |
| | | E₈₋₁₃/E₅₋₂₅ ratio | 1.02 | 1.02 | 1.02 | 1.41 | 1.02 |

| | | | | | | |
|---|---|---|---|---|---|---|
| | Metal cylindrical member (Y: | N | N | N | N | N |
| | provided, N: not provided) | | | | | |
| Evaluation | Temperature difference [surface | −3.61 | −3.28 | −2.70 | −5.82 | −3.38 |
| | temperature of cooling object − | | | | | |
| | outside air temperature] (° C.) | | | | | |

| | | | | | Comparative | Comparative |
|---|---|---|---|---|---|---|
| | | | Example 6 | Example 7 | Example 1 | Example 2 |
| Degree of vacuum P in | | Degree of vacuum P | 3 | 3 | 101325 | 3 |
| vacuum heat insulating | | (Pa) | | | (atmospheric | |
| container | | | | | pressure) | |
| | | Inequality (1) | Y | Y | N | Y |
| | | (Y: satisfied, | | | | |
| | | N: not satisfied) | | | | |
| | | λ(G)/λ(G, 0) ratio | 0.86 | 0.86 | 0.86 | 0.86 |
| Internal far-infrared reflecting film | | | N | N | N | N |
| (Y: provided, N: not provided) | | | | | | |
| Radiative | Far-infrared | Average | 0.75 | 0.76 | 0.76 | 0.76 |
| cooling | transmitting | transmittance T₈₋₁₃ | | | | |
| device | window | T₈₋₁₃/T₅₋₂₅ ratio | 1.75 | 1.35 | 1.35 | 1.35 |
| | member | Solar-ray reflecting | N | N | N | N |
| | | layer (Y: provided, N: | | | | |
| | | not provided) | | | | |
| | | Solar-radiation | 25% | 25% | 25% | 25% |
| | | reflectance | | | | |
| | Far-infrared | Average emittance | 0.94 | 0.94 | 0.94 | None (Al |
| | radiator | E₈₋₁₃ | | | | circular disk) |
| | | E₈₋₁₃/E₅₋₂₅ ratio | 1.02 | 1.02 | 1.02 | |

| | | | | | |
|---|---|---|---|---|---|
| | Metal cylindrical member (Y: | N | Y | N | N |
| | provided, N: not provided) | | | | |
| Evaluation | Temperature difference [surface | −5.30 | −4.50 | −1.98 | −0.02 |
| | temperature of cooling object − | | | | |
| | outside air temperature] (° C.) | | | | |

As shown in Table 1, in Examples 1 to 7 in which vacuum heat insulation was performed, the difference of the temperature of the object with respect to the outside air temperature was large and had good radiative cooling performance as compared with Comparative Example 1 in which vacuum heat insulation was not performed and Comparative Example 2 in which the aluminum circular disk was used instead of the far-infrared radiator.

The contents of the disclosure of JP2016-194976 filed in the Japan Patent Office on Sep. 30, 2016 are incorporated in this specification by reference in its entirety.

All documents, patent applications, and technical standards described in the present specification are incorporated herein by reference to the same extent as when the individual documents, patent applications, and technical standards are specifically and individually described as being incorporated herein by reference.

### REFERENCE SIGNS LIST

10 vacuum heat insulating container

10A opening portion

14 internal far-infrared reflecting film

20 far-infrared transmitting window member

30 far-infrared radiator

41 support pin (support member)

43 pipe

44 valve

46 vacuum forming direction

50 specific far-infrared ray

60 metal cylindrical member

100, 150 radiative cooling device

101 cooling object

What is claimed is:

1. A radiative cooling device comprising:
a vacuum heat insulating container that comprises a container wall, an opening portion, and a housing portion at a position separated from the container wall, the housing portion having a strength that withstands pressure reduction of an interior of the container to 100 Pa or less, the vacuum heat insulating container being configured to housean object to be cooled at an interior thereof and thermally vacuum insulate the object from an exterior thereof;
a far-infrared radiator that is arranged between the object and the opening portion in the vacuum heat insulating container, that is thermally vacuum insulated from the exterior of the vacuum heat insulating container, that thermally contacts the object, and that radiates far-infrared rays in a wavelength range of from 8 μm to 13 μm; and
a far-infrared transmitting window member that closes the opening portion of the vacuum heat insulating container and that transmits the far-infrared rays radiated from the far-infrared radiator.

2. The radiative cooling device according to claim 1, wherein the vacuum heat insulating container thermally vacuum insulates the object and the far-infrared radiator from the exterior of the vacuum heat insulating container with a degree of vacuum of 10 Pa or less.

3. The radiative cooling device according to claim 1,
wherein the far-infrared radiator has an average emittance E₈₋₁₃ in the wavelength range, in a radiation direction of the far-infrared rays, of 0.80 or more, and
wherein the far-infrared transmitting window member has an average transmittance T₈₋₁₃ in the wavelength range, in a transmission direction of the far-infrared rays, of 0.40 or more.

4. The radiative cooling device according to claim 1, wherein the far-infrared radiator is a blackbody radiator.

5. The radiative cooling device according to claim 1, wherein an E₈₋₁₃/E₅₋₂₅ ratio, which is a ratio of an average emittance E₈₋₁₃ of the far-infrared radiator in the wavelength range of from 8 μm to 13 μm in a radiation direction of the far-infrared rays to an average emittance E₅₋₂₅ of the far-infrared radiator in a wavelength range of from 5 μm to 25 μm in the radiation direction of the far-infrared rays, is 1.20 or more.

6. The radiative cooling device according to claim 1, wherein the far-infrared transmitting window member has, at a surface thereof on a side opposite from a surface thereof on a side of the far-infrared radiator, a solar-radiation reflectance of 80% or more.

7. The radiative cooling device according to claim 1, wherein a T₈₋₁₃/T₅₋₂₅ ratio, which is a ratio of an average transmittance T₈₋₁₃ of the far-infrared transmitting window member in the wavelength range of from 8 μm to 13 μm in a transmission direction of the far-infrared rays to an average transmittance T₅₋₂₅ of the far-infrared transmitting window member in a wavelength range of from 5 μm to 25 μm in the transmission direction of the far-infrared rays, is 1.20 or more.

8. The radiative cooling device according to claim 1, further comprising an internal far-infrared reflecting film that is arranged at least between an inner wall surface of the vacuum heat insulating container and the object and that reflects far-infrared rays in a wavelength range of from 5 μm to 25 μm radiated from the inner wall surface when the far-infrared rays in the wavelength range of from 5 μm to 25 μm are radiated from the inner wall surface.

9. The radiative cooling device according to claim 1, further comprising a metal cylindrical member that is arranged on a side opposite from a side of the far-infrared radiator when viewed from the far-infrared transmitting window member and through which the far-infrared rays transmitted through the far-infrared transmitting window member pass.

10. The radiative cooling device according to claim 1, further comprising a support member that is arranged at an inner wall surface of the vacuum heat insulating container and that supports the object.

11. A method of cooling an object, the method comprising disposing the object in a housing portion of the heat insulating container of the radiative cooling device according to claim 1.
